(19) United States
(12) Patent Application Publication
(10) Pub. No.: US 2013/0288110 A1
(43) Pub. Date: Oct. 31, 2013

(54) ASSEMBLY OF AN ELECTRODE STACK OF AN ELECTROCHEMICAL ENERGY STORAGE DEVICE

(71) Applicants: Tim Schaefer, Harztor (DE); Claus-Rupert Hohenthanner, Hanau (DE)

(72) Inventors: Tim Schaefer, Harztor (DE); Claus-Rupert Hohenthanner, Hanau (DE)

(73) Assignee: LI-TEC BATTERY GmbH, Kamenz (DE)

(21) Appl. No.: 13/882,447

(22) PCT Filed: Oct. 27, 2011
(86) PCT No.: PCT/EP2011/005434

§ 371 Date: Jul. 19, 2013

(30) Foreign Application Priority Data
Oct. 29, 2010 (DE) 10 2010 050 040.2

(51) Int. Cl. H01M 2/14

(52) U.S. Cl. CPC H01M 2/14; H01M 2/145
USPC 429/186; 429/246; 429/211; 29/623.1; 29/623.4

(57) ABSTRACT

An assembly of an electrode stack (120) comprises at least one anode layer, at least one cathode layer and at least one separator layer arranged between the at least one anode layer and the at least one cathode layer. Thereby, at least one fixing device (110, 210, 310, 410, 610) is provided which fixes at least two layers of the electrode stack (120) relative to one another, wherein the at least one fixing device consists at least partially of polypropylene.

The present invention relates to the assembly of the electrode stack of an electrochemical energy storage device, preferably a lithium ion battery.

As the need for energy storage devices, particularly lithium ion batteries, continues to steadily grow, the fast, cost-saving and effective manufacturing of such energy storage devices remains indispensable. The manufacturing, particularly the assembly of the individual components, can prove difficult, leading to the risk of producing numerous rejects, which clearly lowers production and cost efficiency. One production step which can be regarded as being critical is inserting the electrode stack into the casing and saturating the electrode stack with electrolyte fluid. It can thereby occur that a stack, frequently consisting of layers, will experience slippages out of position which cause a short circuit, for example, or which lower the charging capacities.

A further problem exists during the use of energy storage devices, lithium ion batteries in particular. The requirements made of energy storage devices have changed in that they are not only expected to be reliable energy suppliers, but they must also function under great stress (e.g. temperature fluctuations, mechanical loads, etc.) for long periods of time. Particularly when employed in the automotive sector, it is very important for an energy storage device to be able to withstand high mechanical loads and vibrations which can occur for example when a vehicle travels over highly varying ground surfaces. It is hereby essential on the one hand for the layers of the electrode stack not to slip or separate from one another and, on the other, for the electrode stack itself not to move around within the casing, whereby the current conductor could e.g. break away.

Various methods of fixation for securing electrode stacks are known from the prior art such as DE 102 51 230 B4, for example, which discloses a vibration-resistant electrochemical cell having indentations in the housing at which the electrode stack can be fixed to the housing.

The invention is based on the object of providing a fixation for the electrode stack which is particularly simple and economical to use.

This object is achieved by the teaching of the independent claims. Preferable further developments of the invention constitute the subject matter of the dependent claims.

As will be described in detail in the following, the object is achieved by the provision of a fixing device which at least partially consists of polypropylene. The advantage in this is that, due to its chemical and physical properties, polypropylene can be particularly easily integrated into the assembly of an electrode stack, a battery cell respectively. For example, depending on its degree of crystallization, the melting point of polypropylene is between 130° C. and 171° C. This can be advantageously utilized during the manufacture of the inventive electrode stack assembly in that the fixing device or its sections comprising polypropylene can later be subject to thermal deformation. It is thereby possible to first place the fixing device or its sections on the electrode stack and thereafter deform same, for example by thermal treatment, in order to e.g. partially or completely melt same intermediately. It thus particularly becomes possible to connect the fixing device and/or a section of the electrode stack connected to said fixing device to further components of the electrode stack assembly, e.g. a casing, by means of melting, for example. Fixing devices consisting wholly or partly of polypropylene are moreover economical and easy to manufacture since polypropylene can be readily processed, for example by means of injection molding or deformation.

The electrode stack assembly preferably comprises a casing which can be connected to the fixing device of the electrode stack, particularly joined together in a form-fit and/or force-fit and/or, particularly preferentially, a bonded connection, particularly preferentially by heat-sealing, melting and/or fusing. Heat-sealing in particular achieves a particularly reliable bond.

An electrode stack comprises at least one cathode, one anode and in particular one separator with electrolyte. The cathode, anode and separator are preferably plate-shaped or foil-like elements.

The plate-shaped elements of the electrode stack are at least partly interconnected by means of an inventive fixing device.

An electrode stack is additionally to be understood as a device which, as a component of an electrochemical cell, also serves in storing chemical energy and emitting electrical energy. To this end, the electrode stack comprises a plurality of plate-shaped elements, at least two electrodes, an anode and a cathode, and a separator at least partially absorbing the electrolyte. The at least one anode, separator and cathode are preferably positioned or stacked one atop the other, wherein the separator is at least partially arranged between the anode and cathode. This sequential arrangement of anode, separator and cathode can be repeated as often as desired within the electrode stack. The plate-shaped elements can also be coiled into an electrode coil. The term “electrode stack” is preferably also used for electrode coils. Before the electrical energy is output, the stored chemical energy is converted into electrical energy. During the charging process, the electrical energy supplied to the electrode stack, or the galvanic cell respectively, is converted into chemical energy and stored. The electrode stack preferably comprises a plurality of electrode pairs and separators. It is particularly preferential for some electrodes to be interconnected, particularly electrically. The use of the term electrode stack in the singular does not exclude the fact that the reference can also be referring to multiple electrode stacks.

To be understood by an anode or an anode layer is a device which stores positively charged ions on interstitial sites during charging. The anode is preferably of a thin-walled design, particularly preferentially as a metal foil, which is coated with anode active material. The anode is preferably of substantially rectangular configuration. The anode is also provided to electrochemically interact with the cathode and/or the electrolyte.

To be understood by a cathode or a cathode layer is a device which also absorbs electrons and positively charged ions during the discharge process or during the emitting of electrical energy respectively. The cathode is preferably of a thin-walled design, particularly preferentially as a metal foil, which is coated with cathode active material. Preferably, the design of a cathode corresponds substantially to the design of an anode of the electrode stack. The cathode is also provided to electrochemically interact with the anode and/or the electrolyte.

In terms of the invention, a separator is to be understood as a device which separates and distances an anode from a cathode. The separator also at least partially absorbs the electrolyte. The separator is preferably of a thin-walled design, particularly preferentially as a polymer foil. Preferably, the design of a separator corresponds substantially to the design of an anode of the electrode stack. A separator is preferably configured from a fibrous web of electrically non-conductive fibers, wherein the fibrous web is coated at least on one side with an inorganic material. EP 1 017 476 B1 describes such a separator and a method of manufacturing same. A separator having the above-described properties going by the name of “Separion” is currently available from the Evonik Degussa GmbH company in Germany.

As defined by the invention, at least one fixing device provides for a fixing of at least one element, for example the electrode stack or one of its components, e.g. an anode layer, cathode layer or separator layer.

In terms of the invention, a “fixation” of two or more elements refers to restricting the ability of said two elements from moving relative to one another. Fixation preferably restricts, preferably prevents, the movement of the elements in preferably at least one degree of freedom, two degrees of freedom or preferably all degrees of freedom, which can preferably ensue by means of at least one fixing device.

The fixing device preferably joins at least two plate-shaped elements of an electrode stack together, e.g. anode layer, cathode layer or separator layer, particularly in a force-fit and/or bonded and/or form-fit connection. A fixing device also serves in preventing relative movements of at least two plate-shaped elements of the electrode stack, particularly an unwanted displacing of at least one plate-shaped element. Preferably, more than two plate-shaped elements of the electrode stack are respectively interconnected. It is particularly preferential for all of the plate-shaped elements of the electrode stack to be connected. A fixing device can also serve in restricting, preferably preventing, the degrees of freedom the electrode stack can move within the casing, preferably by means of a form-fit and/or force-fit and/or bonded connection of the electrode stack to the casing. Such a form-fit and/or force-fit and/or bonded connection of the electrode stack to the casing is preferably realized by at least one point or section of connection. The fixing device for the layers of the electrode stack and the fixing device for the electrode stack within the casing can be identical. Adhesive(s), adhesive tape(s), fastener(s), soldered connection(s) or heat-sealed connection(s) can also preferably serve as means of fixation.

During operation, vibrations or accelerations can lead to unwanted displacing of at least one plate-shaped element of the electrode stack or the entire electrode stack. Unwanted displacing of at least one plate-shaped element can also occur even just when inserting the electrode stack into a housing or a casing. If an electrode is not located at the site within the electrode stack intended for it, the chemical interaction with other plate-shaped elements of the electrode stack is then also reduced, particularly the converting and/or storing of energy. The actual charging capacity of the electrode stack is thereby reduced. The connecting and/or fixing of plate-shaped elements of the electrode stack reduces the unwanted displacing of the individual plate-shaped elements. The chemically active areas of the electrode stack remain available to convert and/or store energy.

If one uses an at least partly foil-like fixing device composed of a polymer other than polypropylene, for example PET, to secure the electrode stack, wrinkling can occur during the further assembling of the electrochemical cell, which can hinder any subsequent closing process there might be, for example a sealing process, and can even lead to electrolyte fluid leaking out from the electrochemical cell provided with a casing.

When fixing devices comprising polypropylene are employed, it has been surprisingly discovered that they can be heat-sealed or fused to the casing, for example when sealing, whereby the disadvantageous consequences of wrinkling, e.g. complicated sealing, are reduced, preferably minimized, preferably equalized; i.e. no longer of relevance. This preferably, but not exclusively, applies when the casing likewise comprises polypropylene.

A casing refers to an at least partial delimitation which at least partially encloses the electrode stack and at least partially delimits it outwardly. The casing is preferably gas-tight and liquid-tight so that can be no material exchange with the surroundings. Electrode stacks are preferably partly or completely disposed within the casing. At least one current conductor, particularly two current conductors, protrude out of the casing and serve to connect the electrode stack. The outwardly projecting current conductors thereby preferably constitute the positive terminal connection and the negative terminal connection of the battery cell. However, a plurality of current conductors, particularly four current conductors, can also extend out of the casing. When the battery cell thereby comprises two electrode stacks connected in series, two electrodes of different electrode stacks are then interconnected. The casing is to compromise the passage of thermal energy to the smallest extent possible. In the present case, the casing comprises at least two molded parts. At least parts of said molded parts preferably fit snugly against an electrode stack. The casing can be of foil-like design. The casing preferably at least partially comprises composite material. The side of the casing's composite material facing the electrode stack preferably comprises polypropylene or another polymer which can be heat-sealed or fused to polypropylene, whereby the polypropylene-comprising fixation of the electrode stack to the casing is advantageously heat-sealable or fusible.

By definition, a current conductor is an element manufactured from a conductive material. It serves in conducting current between two geometrically distanced points. In the present case, a current conductor also refers to a device which enables the flow of electrons from one electrode to an electrical load. The current conductor also works in the opposite direction of current. At least one current conductor extends from the casing and can thereby serve in the outward connecting of the battery cell. A current conductor can be electrically connected to an electrode, an active electrode mass respectively, or to the conductor tab(s) of the electrode stack's electrodes and then further to a connecting lead. The design of the current conductor is adapted to the design of the electrochemical cell/electrode stack. A current conductor is of preferably plate-shaped or foil-like design. Each electrode or each conductor tab of the electrode stack preferentially has its own current conductor, respectively electrode or conductor tabs of like polarity are connected to a common current conductor. A first current conductor can partly extend out of the casing. A second current conductor can partly extend out of the casing or can form a conductive connection between two electrode stacks. A current conductor is preferably partially coated, wherein the coating is particularly configured to be electrically insulating. At least one current conductor is also preferably connected to a conductor tab in heat-conducting manner. The connection, particularly the heat conducting and/or electrically conductive connection, is preferably made between at least one conductor tab and at least one current conductor by heat-sealing, whereby ultrasonic welding is particularly preferred. When a plurality of current conductors are utilized, they can protrude from the casing on the same side or from different sides.

By definition, a conductor tab is connected to an electrode stack. In particular, the conductor tab is thereby connected to all of an electrode stack's like electrodes; i.e. either to the cathodes or to the anodes. Obviously, a conductor tab is not concurrently connected to the electrode stack's cathodes and anodes since doing so would cause a short circuit. However, a conductor tab can be connected to different electrodes of different electrode stacks; thus in the case of a series connection of two electrode stacks, for example. The conductor tab can be integrally formed with one or more electrodes. A delimitation between conductor tab and electrode can be seen in the conductor tab particularly not being coated with active electrode material. The conductor tab can be of one-piece or multi-piece design, respectively single-layered or multi-layered, of an electrically and/or thermally conductive material, preferably aluminum or copper. All the conductor tabs are preferably of equal length or have ends equally distanced from the electrode stack.

Preferred further developments of the invention will be described in the following.

The electrode stack preferably comprises a plurality of, at least two, cathodes, anodes and separators. It is further preferable for the electrode stack to comprise a plurality of, at least ten, anodes, cathodes and separators. Further preferential is for the electrode stack to comprise 30 cathodes and anodes and 60 separators. Cathode(s), anode(s) and separator(s) are in each case of plate-shaped configuration.

The fixing device is preferably designed as or comprises an adhesive connection. In particular, the adhesive connection constitutes at least one adhesive strip. At least one adhesive strip thereby also secures the plate-shaped elements both during manufacture as well as during subsequent operation. An adhesive material can be applied to a carrier as an adhesive strip, wherein the carrier in particular permanently remains on the bonded plate-shaped elements and also transmits forces. The carrier preferentially comprises polypropylene, preferably consisting of same completely or at least partially, and is chemically resistant to the electrolyte. Acrylate adhesives or silicone adhesives are preferably employed as the adhesive. The adhesive can be deposited on one or both sides of the carrier. The adhesive strip is preferably disposed on the electrode stack such that the side of the carrier coated with the adhesive faces the electrodes; although the side coated with the adhesive can also face the casing. At least one adhesive strip is preferably disposed on at least one outer edge of one or more of the plate-shaped elements.

At least one adhesive strip preferentially runs at least partly around the electrode stack or around the entire electrode stack. Preferably, at least one adhesive strip is disposed on at least one corner of the electrode stack. At least one adhesive strip is preferably disposed on at least one side of the electrode stack. At least one adhesive strip is preferably a component of a frame which can also enclose the plate-shaped elements and additionally stabilize the electrode stack. Preferentially, the adhesive strip does not also need to be additionally manufactured and attached to the frame.

The fixing device is preferably arranged as at least one adhesion point between plate-shaped elements, particularly at the corners of the plate-shaped elements. An adhesion point is easily affixed to well-defined locations and also provides proper fixing of the electrode stack's elements. The plate-shaped elements are preferably connected to a plurality of adhesion points, particularly at the corners of the electrode stack. At least part of an adhesion point is preferably designed as a body composed preferably at least partially or preferably mostly or preferably entirely of polypropylene and which can be at least partially coated on the surface with an adhesive, preferably an acrylate adhesive or a silicone adhesive. An adhesion point is preferably a plate-like element, the surface of which is very small compared to the surface of the cathode, anode or separator, particularly by a factor of 50, 100, 200 or 500 times smaller than the cathode, anode or separator surface.

Preferably, at least one adhesive bead is formed between the plate-shaped elements or along at least one edge of a plate-shaped element. Preferably, a plurality of plate-shaped elements are connected to a plurality of adhesive beads along their boundary edges. Such adhesive beads not only stabilize the assembly of the electrode stack's individual plate-shaped elements relative each other, but also advantageously act as additional insulation to reduce energy losses at the boundary edges of the electrodes. At least part of an adhesive bead is preferably configured as a body composed preferably at least partially or preferably mostly or preferably entirely of polypropylene and which can be at least partially coated on the surface with an adhesive, preferably an acrylate adhesive or a silicone adhesive. An adhesive bead is preferably an elongated, plate-like or cylinder-like component, the length of which is greater than its width by a factor of at least 2, 5, 10, 50 or 100.

The fixing device preferentially comprises a lug which preferably consists at least partially of polypropylene, preferably mainly of polypropylene, or preferably entirely of polypropylene, and which can be fused to the casing, and at least partially coated on the surface with an adhesive, preferably an acrylate adhesive or a silicone adhesive.

The fixing device is preferably of one-piece or multi-piece design.

Multiple components of at least one fixing device or a plurality of fixing devices can preferably be distanced from one another, preferably so as to obtain an evenly distributed arrangement of the fixing device components on and/or around the electrode stack.

Preferentially, multiple components of at least one fixing device or a plurality of fixing devices can be in contact with one another, particularly joined together in a form-fit and/or force-fit and/or bonded connection.

The fixing device is preferentially of flexible, in particular elastic, or rigid design, or can comprise flexible and/or rigid components.

An electrochemical cell of an electrode stack preferably exhibits a casing and/or packing for the electrode stack and electrical connections, respectively the current conductor and/or conductor tabs to the electrodes. The casing also separates the electrode stack from the environment and prevents electrolyte from leaking out. Securing the plate-shaped elements of the electrode stack among themselves makes such an electrode stack particularly suited to the assembling of an electrochemical cell. The mutually fixed position of the plate-shaped elements of the electrode stack also remains an advantage during the later operation of the electrochemical cell.

The invention also relates to the method of manufacturing an electrode stack assembly comprising at least one anode layer, at least one cathode layer and at least one separator layer arranged between said at least one anode layer and said at least one cathode layer, wherein the method comprises the step of providing a fixing device which fixes the stacked electrode layers and the separator layer(s) arranged therebetween, wherein the fixing device consists at least partially of polypropylene.

The method preferably comprises the step of disposing at least part of at least one fixing device, preferably at least one adhesive strip, on at least one electrode. In accordance with the invention, a method for manufacturing an electrochemical cell is also provided which preferably includes the steps of the inventive method for manufacturing the inventive electrode stack assembly.

The electrode stack is preferentially manufactured such that its plate-shaped elements are positioned by means of least one positioning aid, in particularly by at least one gauge or frame and/or at least one fastening means. A positioning aid preferably comprises at least one edge guide for at least one respective boundary edge of a plate-shaped element. A positioning aid is preferably provided such that it renders automated positioning of plate-shaped elements as a part of a manufacturing apparatus.

The electrode stack, the respective electrodes of which comprise at least one conductor tab, is preferably manufactured such that at least one conductor tab of a cathode and/or an anode is in each case used for their positioning. The boundary edges of the conductor tabs are thereby in particular in parallel alignment. A positioning aid preferably interacts with the conductor tabs during the manufacture of the electrode stack, particularly when the plate-shaped elements are being stacked. In particular, a positioning aid comprises at least one edge guide for at least one respective boundary edge of a conductor tab.

It is preferential for the electrode stack, the respective electrodes of which comprise at least one conductor tab, to be manufactured such that at least two conductor tabs are connected together after being positioned, particularly joined together in a form-fit and/or force-fit and/or bonded connection. This connection is preferably provided by means of soldering or heat-sealing. Depending on the arrangement of the electrodes, or their conductor tabs respectively, the electrodes can be interconnected in parallel and/or series during connection. Preferably, at least one current conductor is connected to at least two conductor tabs of an electrode, for example the cathode, in particular so as to be electrically or thermally conductive and/or joined together in a bonded and/or form-fit and/or force-fit connection, particularly by heat-sealing, with ultrasonic welding being particularly preferred. Depending on the arrangement of the electrodes and/or their conductor tabs, the conductor tabs can exhibit different lengths after having been positioned. The conductor tabs of different lengths can preferably be made all one length, preferably by cutting, particularly by laser cutting, after being positioned and prior to or subsequent their optional connection, but before being connected to at least one current conductor. Prior to or subsequent their positioning and/or prior to or subsequent their connection and/or prior to or subsequent their connection to the at least one current conductor, the conductor tabs can be bent and/or curled and/or coiled and/or angled and/or twisted and/or their original orientation of expansion, e.g. in the z-direction, altered by other methods, such after the method has been implemented, the main orientation of expansion is different, e.g. in the x-direction, or the original is restored.

The electrode stack is preferably manufactured such that at least two plate-shaped elements are connected to at least one adhesive strip. Preferably, a plurality of plate-shaped elements are connected by means of at least one adhesive strip. At least one adhesive strip is preferentially affixed at least partially along at least one respective boundary edge of at least two plate-shaped elements. At least one adhesive strip is preferably affixed to at least one respective corner of at least two plate-shaped elements. At least one adhesive strip is preferentially affixed around the electrode stack. Adhesives tapes are also used synonymously with adhesive strips.

It is particularly preferential for four adhesive strips to be affixed on the side opposite the current conductors, two adhesive strips each on the side perpendicular to the current conductor side, and one adhesive strip between the current conductors on the electrode stack. The respective adhesive strips preferably exhibit a first electrode layer and a last electrode layer. Said adhesive strips can also be configured as fasteners. It is particularly preferential for the adhesive strip carrier material to be composed of polypropylene.

The electrode stack is preferably manufactured such that at least one adhesion point is affixed for the bonding of at least two plate-shaped elements. The at least one adhesion point is preferably affixed between two plate-shaped elements. Preferably, at least one respective adhesion point is affixed to a respective boundary edge of at least two plate-shaped elements. At least one adhesive bead is preferably deposited between two plate-shaped elements. At least one adhesive bead is preferably deposited along part of a respective boundary edge of at least two plate-shaped elements.

Fixing means are preferably affixed to the plate-shaped elements of the electrode stack prior to the stacking. Thus, the stack is also already secured prior to manufacture such that an otherwise necessary aligning of the plate-shaped elements of the electrode stack becomes unnecessary. In this case, the fixing means can again be adhesive strips or adhesion points or fasteners, whereby, however, the adhesive material does not necessarily have to be resistant to the electrolyte since the fixing means only needs to last during the manufacturing steps and can thereafter be replaced by the fixing means subsequent stacking and during assembling. A liquid adhesive or a hot-melt adhesive which hardens immediately can preferably be selected to be used as the fixing means prior to the stacking of the plate-shaped elements of the electrode stack. An acrylate adhesive or an EVA-modified PE hot-melt adhesive are preferably conceivable as adhesive.

An electrochemical cell or galvanic cell is preferably manufactured such that an electrode stack which has been secured in the above-described manner, is conveyed into a casing, wherein the pre-fixing of the stack is advantageous with respect to its manufacturing, both when inserting the electrode stack into the casing as well as also later during its operation within the casing. The casing can in particular be a composite film or a rigid housing. The casing also separates the electrode stack from its surroundings and prevents electrolyte from leaking out.

The following description made in conjunction with the figures will yield further advantages, features and conceivable applications of the present invention.

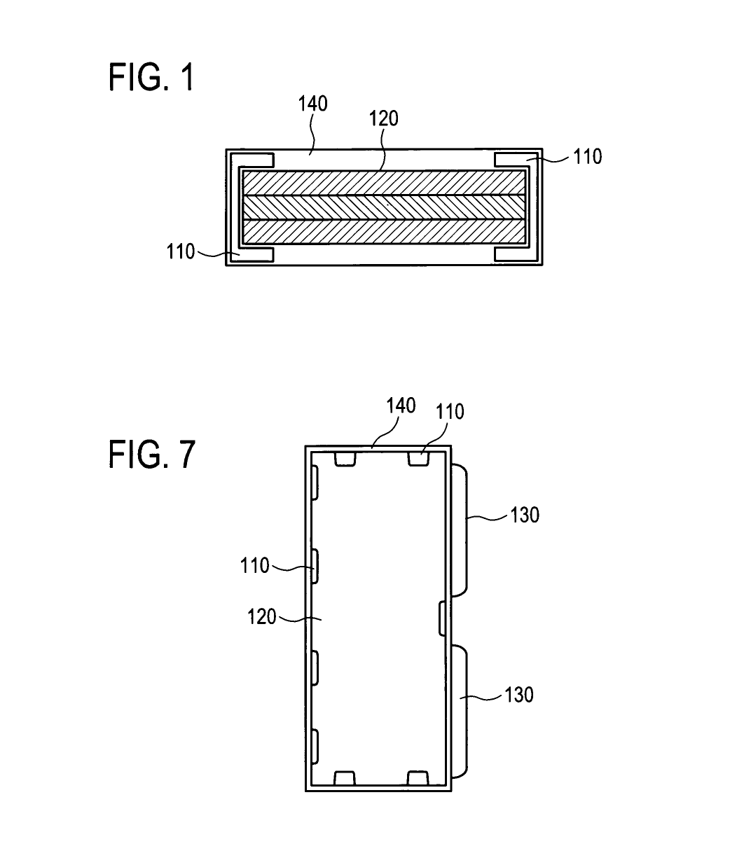

FIG. 1 is a schematic cross-section view of a first embodiment of the electrode stack assembly according to the invention;

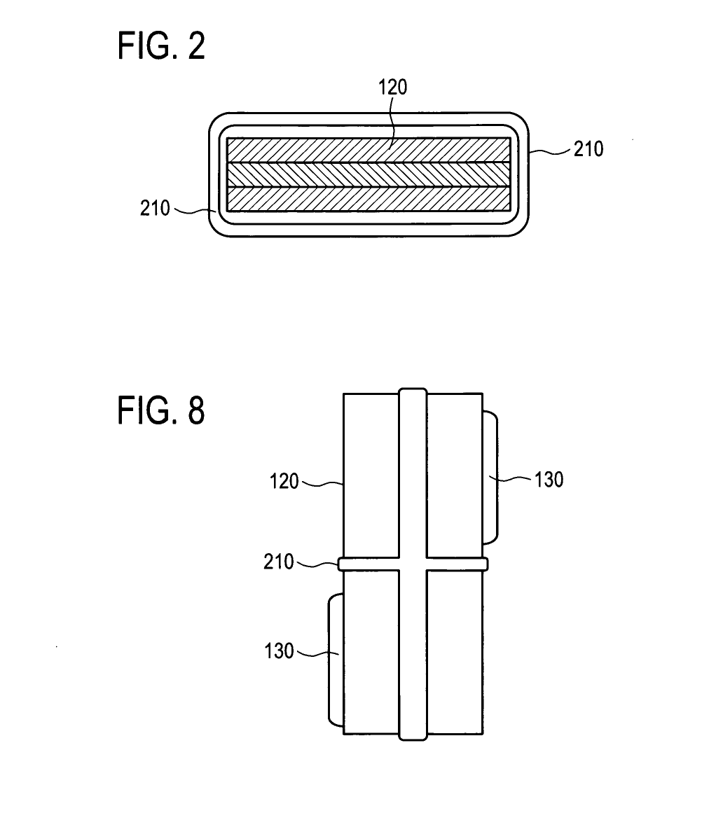

FIG. 2 is a schematic cross-section view of a second embodiment of the electrode stack assembly according to the invention;

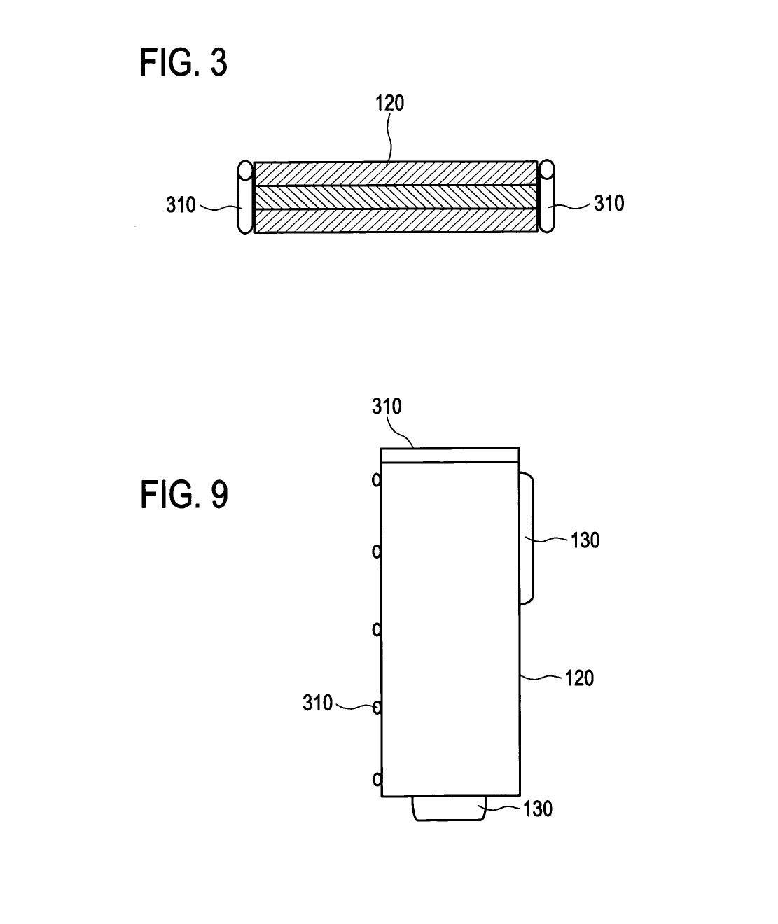

FIG. 3 is a schematic cross-section view of a third embodiment of the electrode stack assembly according to the invention;

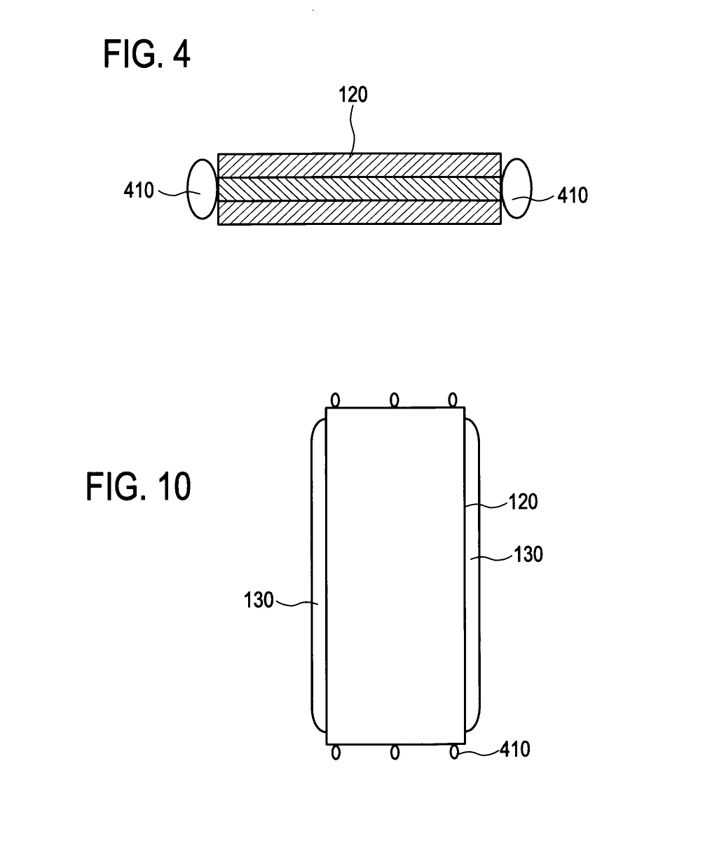

FIG. 4 is a schematic cross-section view of a fourth embodiment of the electrode stack assembly according to the invention;

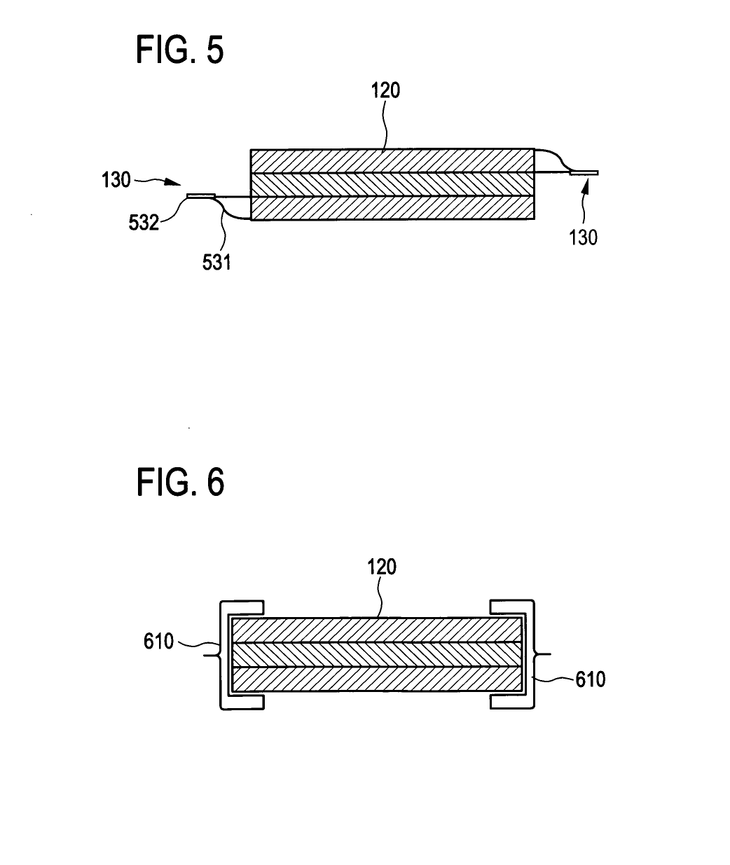

FIG. 5 is a schematic cross-section view of a fifth embodiment of the electrode stack assembly according to the invention;

FIG. 6 is the schematic cross-section view of a sixth embodiment of the electrode stack assembly according to the invention;

FIG. 7 is the schematic view of the electrode stack assembly of FIG. 1 as seen from above;

FIG. 8 is the schematic view of the electrode stack assembly of FIG. 2 as seen from above;

FIG. 9 is the schematic view of the electrode stack assembly of FIG. 3 as seen from above;

FIG. 10 is the schematic view of the electrode stack assembly of FIG. 4 as seen from above; and

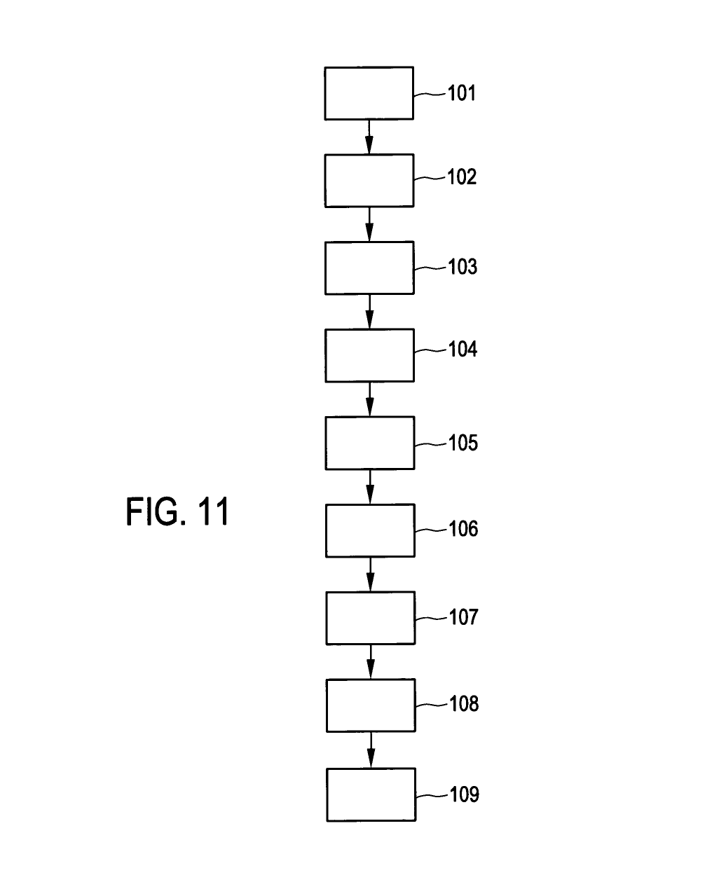

FIG. 11 is an embodiment of the inventive method for assembling an electrode stack assembly in accordance with the invention.

In accordance with FIGS. 1 and 7, an electrode stack comprises electrode layers 120 of alternating anode, cathode and separator layers (sequence variable) as well as fasteners or adhesive tapes 110 affixed to the sides of the electrode stack 120 in a perpendicular orientation to the electrode layers.

The fasteners or adhesive tapes 110 can be arranged on all four sides of the electrode stack as depicted in FIGS. 1 and 7. The fasteners or adhesive tapes 110 can, however, also be arranged on three or two or one side(s) of the electrode stack 120. A preferential arrangement of the adhesive tapes or fasteners 110 is as follows: arranging four adhesive tapes or fasteners 110 at equal distances on the side opposite the side comprising the conductor tabs with attached current conductors 130; arranging two adhesive tapes or fasteners 110 each on both sides disposed at least perpendicular to the side comprising the conductor tabs with attached current conductors 130; arranging one adhesive band or one fastener 110 between the two conductor tabs with attached current conductors 130. The conductor tabs with attached current conductors 130 can protrude into the surroundings from the same side of the electrode stack 120 as depicted in FIGS. 1 and 7. The conductor tab(s) with attached current conductors 130 can protrude into the surroundings from the electrode stack at the same or differing heights, for example a conductor tab with attached current conductor 130 extends into the surroundings from the electrode stack at the height of the first cathode layer, while a second conductor tab with attached current conductor 130 extends into the surroundings from the electrode stack at the height of the last cathode layer (not shown).

FIGS. 1 and 7 also indicate a foil-like casing 140 which encases the electrode stack 120 so as to be fluid-tight; i.e. gas-tight and liquid-tight. The current conductor 130 extends at least partially from said casing 140. Although not depicted, this or another casing 140 is generally also provided in the other embodiments of FIGS. 2 to 10.

In accordance with FIGS. 2 and 8, an electrode stack comprises electrode layers of alternating anode, cathode and separator layers (sequence variable) as well as adhesive tapes 210 which completely wrap around the electrode stack 120 once. The directional orientation of the adhesive tapes 210 can be perpendicular to one another, although a vertical and/or parallel orientation to one another is also possible. The number of adhesive tapes 210 used is variable. The conductor tab(s) with current conductor 130 project into the surroundings from opposite sides of the electrode stack 120. The conductor tab(s) with affixed current conductors 130 can protrude into the surroundings from the electrode stack at the same or differing heights (not shown).

In accordance with FIGS. 3 and 9, an electrode stack comprises electrode layers of alternating anode, cathode and separator layers (sequence variable) as well as a plurality of adhesive beads 310 which are affixed to different sides in perpendicular and/or parallel orientation to the layers on the sides of the electrode stack 120. The conductor tabs with affixed current conductor 130 project into the surroundings from opposite sides of the electrode stack. The conductor tab(s) with affixed current conductors 130 can protrude into the surroundings from the electrode stack 120 at the same or differing heights (not shown).

In accordance with FIGS. 4 and 10, an electrode stack 120 comprises electrode layers of alternating anode, cathode and separator layers (sequence variable) as well as adhesion points 410 affixed to opposite sides of the electrode stack. The adhesion points 410 can, however, also be affixed to one, three or four side(s) of the electrode stack 120 (not shown). The conductor tab(s) with current conductor 430 extend into the surroundings from the electrode stack on opposite sides along the entire length of the electrode stack's sides. The conductor tab(s) with affixed current conductors 130 can protrude into the surroundings from the electrode stack at the same or differing heights (not shown).

According to FIG. 5, an electrode stack 120 comprises electrode layers of alternating anode, cathode and separator layers (sequence variable). The schematic cross-sectional view of the embodiment (FIG. 5) shows how the bundled conductor tabs 531 of the anodes and/or cathodes extend from the electrode stack 120 into the surroundings at different electrode stack heights. The current conductors 532 can overlap the conductor tabs 531 over a specific area.

According to FIG. 6, an electrode stack 120 comprises electrode layers of alternating anode, cathode and separator layers (sequence variable) as well as adhesive tapes or fasteners comprising lugs 610 affixed to the sides of the electrode stack 120.

In accordance with FIG. 11, the method of assembling an embodiment of an electrode stack assembly 120 comprises the following method steps in optional order:
Providing an electrode stack (step 101),
Providing nine safety devices configured as adhesive strips (step 102),
Disposing the safety devices on the electrode stack (step 103), wherein a preferential arrangement of the nine safety devices is as follows: disposing one safety device between the conductor devices extending out of the electrode stack from one side; disposing four safety devices on the side opposite the side with the conductor tabs, disposing two safety devices each on the two sides disposed perpendicular to the side with the conductor tabs,
Positioning the conductor tabs (step 104),
Cutting the conductor tabs, preferably by laser, to a substantially equal length (step 105),
Connecting the conductor tabs to the current conductors, preferably by ultrasonic welding (step 106),
Providing the casing (step 107),
Arranging the casing on the electrode stack with safety device(s) as assembled in method step 103 (step 108),
At least partially sealing the electrode stack with safety device(s) and casing as assembled in method step 105, preferably by heat-sealing and/or fusing (step 109).

### LIST OF REFERENCE NUMERALS

101-109 method steps
110 adhesive tape or fastener
120 electrode stack
130 conductor means/conductor tab(s) with current conductor
140 casing
210 adhesive tape or fastener
310 adhesive bead
410 adhesion point
531 conductor tab(s)
532 current conductor
610 adhesive tape or fastener with lug

1-15. (canceled)

16. An assembly of an electrode stack comprising:
at least one anode layer;
at least one cathode layer;
at least one separator layer arranged between said at least one anode layer and said at least one cathode layer; and
at least one fixing device which fixes at least two layers of the electrode stack relative to one another, wherein said at least one fixing device is configured as an adhesive bead or an adhesion point comprised of polypropylene and being affixed to one side of the electrode stack.

17. The assembly according to claim 16, wherein the fixing device is configured as an adhesive strip, an adhesive bead or an adhesion point comprising polypropylene.

18. The assembly according to claim 16, wherein the at least one fixing device fixes the stacked anode, cathode, and separator layers of the electrode stack.

19. The assembly according to claim 16, wherein the fixing device joins together the anode layers, cathode layers, and/or separator layers of the electrode stack in a force-fit and/or bonded and/or form-fit connection.

20. The assembly according to claim 16, wherein the electrode stack comprises at least one conductor tab fixed by means of a fixing device.

21. An electrochemical cell comprising:
at least one electrode stack; and
at least one casing which at least partially encases the electrode stack;
wherein the electrode stack comprises at least one anode layer, at least one cathode layer, at least one separator layer arranged between said at least one anode layer and said at least one cathode layer, and at least one fixing device fixing at least two layers of the electrode stack relative to one another, wherein said at least one fixing device is configured as an adhesive bead or an adhesion point comprised polypropylene and being affixed to one side of the electrode stack.

22. The electrochemical cell according to claim 21, wherein the casing comprises composite material which comprises at least one inner layer comprised of polypropylene.

23. The electrochemical cell according to claim 22, wherein the fixing device and/or the electrode stack are bonded to the casing in a material connection by the fixing device being heat-sealed to the inner layer of the casing.

24. A method of manufacturing an assembly of an electrode stack comprising at least one anode layer, at least one cathode layer, and at least one separator layer arranged between said at least one anode layer and said at least one cathode layer, the method comprising:
fixing at least two layers of the electrode stack relative to one another by means of at least one fixing device comprised of polypropylene.

25. The method according to claim 24, wherein the at least one fixing device is configured as an adhesive strip, an adhesive bead, or an adhesion point comprising polypropylene.

26. The method according to claim 24, further comprising:
affixing at least one conductor tab of the electrode stack to at least one current conductor, particularly in a force-fit and/or form-fit and/or bonded joining manner.

27. The method according to claim 26, wherein the at least one conductor tab of the electrode stack is affixed to at least one current conductor by heat-sealing or ultrasonic welding.

28. The method according to claim 24, further comprising:
bundling at least two conductor tabs of the electrode stack prior to their being affixed to at least one current conductor; and
making the at least two conductor tabs all the same length.

29. The method according to claim 24, further comprising:
arranging a casing around the fixed electrode stack.

30. The method according to claim 29, further comprising:
joining the casing to the fixing device and/or the electrode stack, particularly in a bonded connection.

31. The method according to claim 30, wherein the casing comprises composite material which comprises an inner layer comprising polypropylene; and the fixed electrode stack is heat-sealed to the casing.
